(19) United States
(12) Patent Application Publication
(10) Pub. No.: US 2006/0165897 A1
(43) Pub. Date: Jul. 27, 2006

(54) Pattern forming method, droplet discharge head, pattern forming device, method for manufacturing color filter substrate, color filter substrate, method for manufacturing electro-optical device, and electro-optical device

(75) Inventor: Tatsuya Ito, Matsumoto (JP)

Correspondence Address: GLOBAL IP COUNSELORS, LLP, 1233 20TH STREET, NW, SUITE 700, WASHINGTON, DC, 20036-2680, US

(73) Assignee: Seiko Epson Corporation, Shinjuku-ku (JP)

(21) Appl. No.: 11/329,139

(22) Filed: Jan. 11, 2006

(30) Foreign Application Priority Data
Jan. 21, 2005 (JP) JP 2005-013701

(51) Int. Cl. B05D 5/00; B05C 5/00; B05D 1/36; B05C 11/00

(52) U.S. Cl. 427/258; 118/300; 118/46; 118/679

(57) ABSTRACT

A pattern forming method is for forming a pattern on a substrate that has a pattern forming region on its one surface. The pattern forming method includes scanning in a first direction the substrate provided with the pattern forming region; and discharging droplets containing pattern forming material into the pattern forming region from a droplet discharge head that is provided with a droplet discharge nozzle. The droplet discharge head is relatively oscillated relative to the one surface of the substrate by oscillating one of the droplet discharge head and the one surface relative to the other of the droplet discharge head and the one surface of the substrate in a direction different from the first direction, such that the droplets are discharged from the droplet discharge nozzle when the droplet discharge head faces the pattern forming region.

### BACKGROUND

1. Technical Field

The present invention relates to a pattern forming method, droplet discharge head, pattern forming device, method for manufacturing color filter substrate, color filter substrate, method for manufacturing electro-optical device, and electro-optical device.

2. Related Art

Known methods for manufacturing color filters installed in liquid crystal display devices and the like use liquid phase processes for discharging solutions of colored layer forming materials of each color on pixel forming regions of a substrate, and drying the solutions to form the colored layers. Among these liquid phase processes, inkjet methods can form finer colored layers (patterns) than other liquid phase methods (for example, spin coat methods and dispenser methods) because the solution is discharged as fine droplets.

Droplet discharge devices used in inkjet methods are provided with a droplet discharge head that has a plurality of nozzles arranged in rows at a predetermined pitch width. The droplet discharge device arranges a substrate provided with pixel forming regions on the discharge side of the droplet discharge head, and scans in one direction this substrate while discharging fine droplets from nozzles positioned directly above each pixel forming region. In this way droplets configured as fine droplets can be formed in all pixel forming regions of the substrate, so as to form fine colored layers.

The shape of the colored layer formed in each pixel forming region is dependent on the shape of the droplets formed in each pixel forming region, that is, the disposition of the nozzles directly over each pixel forming region. Therefore, in order to form colored layers having uniform shapes (uniform film thickness), the nozzles positioned above the scanning path of each pixel forming region must be uniformly disposed.

Known inkjet methods propose to uniformly arrange the nozzles on the scanning path of each pixel forming region (for example, refer to JP-A-2002-273868). In P JP-A-2002-273868, a droplet discharge head (nozzle array) is inclinably arranged relative to the scan direction of the substrate, such that the pitch width of the nozzles viewed from the scan direction is a relative pitch width of the pixel forming regions. Thus, the nozzles can be uniformly disposed on the scanning path of each pixel forming region, and uniformly shaped colored layers can be formed.

In order to accurately match the relative position of the nozzle on the pixel forming region, a high degree of position adjustment is necessary; for example, a micron order of precision is required. Moreover, when forming droplets by a plurality of droplet discharge heads, this high degree of position adjustment is required for each droplet discharge head. As a result, problems arise in the disclosure of JP-A-2002-273868 inasmuch as the operating time of the droplet discharge device is greatly reduced by the positional adjustment of the inclination of the droplet discharge head (nozzle array), thus reducing the production of the color filters.

### SUMMARY

An advantage of the invention is to provide a pattern forming method, droplet discharge head, pattern forming device, method for manufacturing color filter substrate, color filter substrate, method for manufacturing electro-optical device, and electro-optical device which improve production characteristics and improve the uniformity of pattern shape.

The pattern forming method of one aspect of the invention is a pattern forming method for forming a pattern on a substrate that has a pattern forming region on its one surface. The pattern forming method includes scanning in a first direction the substrate provided with the pattern forming region; and discharging droplets containing pattern forming material into the pattern forming region from a droplet discharge head that is provided with a droplet discharge nozzle. The droplet discharge head is relatively oscillated relative to the one surface of the substrate by oscillating one of the droplet discharge head and the one surface relative to the other of the droplet discharge head and the one surface of the substrate in a direction different from the first direction, such that the droplets are discharged from the droplet discharge nozzle when the droplet discharge head faces the pattern forming region.

The pattern forming method of this aspect can increase the range of movement of the droplet discharge nozzle relative to the pattern forming region and can discharge droplets within this increased relative movement range due to the relative oscillation of the droplet discharge head relative to the one surface of the substrate. Therefore, the droplets can be uniformly discharged in the pattern forming region by the increase in the relative movement range. As a result, there is improved uniformity of the pattern shape in the pattern forming region, and improved pattern production characteristics.

In this pattern forming method, the droplet discharge head is relatively oscillated relative to the one surface of the substrate by oscillating the droplet discharge head in the direction different from the first direction.

The pattern forming method can increase the relative movement range of the droplet discharge nozzle relative to the pattern forming region, and can discharge droplets within the increased relative movement range by simply oscillating the droplet discharge head.

In this pattern forming method, the droplet discharge head is relatively oscillated relative to the one surface of the substrate by oscillating the droplet discharge head in the direction different from the first direction.

The pattern forming method can increase the relative movement range of the droplet discharge nozzle relative to the pattern forming region, and can discharge droplets within the increased relative movement range by simply oscillating the substrate.

In this pattern forming method, the droplet discharge head is relatively oscillated relative to the one surface of the substrate in a direction perpendicular to the first direction within the one surface of the substrate. This pattern forming method can further increase the relative movement range of the droplet discharge nozzle in the pattern forming region by simply relatively oscillating the droplet discharge head in a direction perpendicular to the scanning direction of the substrate. Accordingly, there is further improved uniformity of the pattern shape in the pattern forming region, and further improved pattern production characteristics.

In this pattern forming method, droplets are discharged from the droplet discharge nozzle, such that a total amount of droplets discharged from the droplet discharge nozzle to each of a plurality of pattern forming regions formed on the one surface of the substrate is uniform.

This pattern forming method can uniformly discharge droplets in a uniform total amount in each pattern forming region. Accordingly, there is even further improved uniformity of the pattern shape in the pattern forming region, and further improved pattern production characteristics.

In this pattern forming method, the total amount of droplets discharged from the droplet discharge head to each of the plurality of pattern forming regions is made uniform by adjusting at least one of the number and the weight of the droplets discharged from the droplet discharge nozzle.

This pattern forming method adjusts at least either the weight or the number of the droplets discharged in each pattern forming region so as to uniformly discharge the uniform total amounts of droplets. Accordingly, there is even further improved uniformity of the pattern shape in the pattern forming region, and further improved pattern production characteristics.

In this pattern forming method, droplets are discharged from the droplet discharge nozzle when the droplet discharge nozzle is positioned a distance shorter than a predetermined distance from a center line along one direction of the pattern forming region.

This pattern forming method reliably discharges droplets near the center line along the first direction, and reliably avoids deflecting droplets within the pattern forming region by broadly wetting discharged droplets from near the center line.

The droplet discharge head of another aspect the invention is provided with a droplet discharge nozzle from which droplets containing pattern forming material are configured to be discharged onto a pattern forming region of a substrate that is scanned in a first direction; and an oscillation unit configured to oscillate the droplet discharge nozzle in a direction different from the first direction.

The droplet discharge head of this aspect can uniformly discharge droplets in the pattern forming region simply by increasing the relative movement range of the droplet discharge nozzle relative to the substrate using the oscillation unit. As a result, there is improved uniformity of the pattern shape in the pattern forming region, and improved pattern production characteristics.

The pattern forming device of still another aspect of the invention includes a scanning unit configured to scan in a first direction a substrate having a pattern forming region on its one surface; a droplet discharge head having a droplet discharge nozzle from which droplets containing pattern forming material are configured to be discharged in the pattern forming region; an oscillating unit configured to relatively oscillate the droplet discharge head relative to the one surface of the substrate in a direction different from the first direction; and a control unit configured to control the droplet discharge nozzle so as to discharge droplets when the droplet discharge nozzle faces the pattern forming region.

The pattern forming device of this aspect uniformly discharges droplets with the control unit simply by increasing the relative movement range of the droplet discharge nozzle relative to the pattern forming region using the oscillation unit. As a result, there is improved uniformity of the pattern shape in the pattern forming region, and improved pattern production characteristics.

In this pattern forming device, the oscillation unit is disposed adjacent to the droplet discharge head, and is configured to impart a predetermined oscillation to the droplet discharge head.

The pattern forming device can increase the relative movement range of the droplet discharge nozzle relative to the pattern forming region, and can discharge droplets within the increase relative movement range by simply having the oscillation unit oscillate the droplet discharge head.

The method for manufacturing a color filter of still another aspect of the invention is a method for manufacturing a color filter substrate, and includes scanning in a first direction a substrate having a colored layer forming region on its one surface; and discharging within the colored layer forming region droplets containing colored layer forming material from a droplet discharge head provided with a droplet discharge nozzle so as to form a colored layer in the colored layer forming region. The colored layer is formed by the above-described pattern forming method.

The method for manufacturing a color filter of this aspect of the invention can improve the uniformity of the shape of the colored layer, and improve the production characteristics of the color filter.

A color filter substrate of still another aspect of the invention is manufactured by the previously described method for manufacturing a color filter substrate.

The color filter of the invention can improve the uniformity of the shape of the colored layer, and improve the production characteristics of the color filter.

An electro-optical device of still another aspect of the invention includes an element substrate and an opposite substrate; and an electro-optic material layer disposed between the element substrate and the opposite substrate. The opposite substrate is the above described color filter substrate.

The electro-optical device of the invention can improve the uniformity of the colored layer, and improve the production characteristics of the electro-optical device.

The method for manufacturing the electro-optical device of still another aspect of the invention includes scanning in a first direction a substrate having a light-emitting element forming region on its one surface; and discharging within the light-emitting element forming region droplets containing light-emitting element forming material from a droplet discharge head provided with a droplet discharge nozzle so as to form a light-emitting element in the light-emitting element forming region. The light-emitting element is formed by the above-described pattern forming method.

The method for manufacturing an electro-optical device of this aspect of the invention can improve the uniformity of the shape of the light-emitting element, and improve the production characteristics of the electro-optical device.

An electro-optical device of still another aspect of the invention is manufactured using the method for manufacturing an electro-optical device.

The electro-optical device of the invention can improve the uniformity of the shape of the light-emitting element, and improve the production characteristics of the electro-optical device.

### BRIEF DESCRIPTION OF THE DRAWINGS

FIG. 1 is a perspective view of a droplet discharge device of a first embodiment of the invention;

FIG. 2 is a perspective view of the droplet discharge head of the same embodiment;

FIG. 3 is a perspective view of the droplet discharge head of the same embodiment;

FIG. 4 is a cross section view of the droplet discharge head of the same embodiment;

FIG. 5 is a cross section view of the droplet discharge head of the same embodiment;

FIG. 6 is a perspective view of the color filter of the same embodiment;

FIG. 7 is a cross section view of the color filter;

FIG. 8 is a block diagram showing the electrical structure of the droplet discharge device;

FIG. 9 illustrates the droplet discharge operation of the droplet discharge device;

FIG. 10 similarly illustrates the droplet discharge operation of the droplet discharge device;

FIG. 11 is a cross section view of the color filter of the same embodiment; and

FIG. 12 is a perspective view of a liquid crystal device of a second embodiment of the invention.

### DESCRIPTION OF EXEMPLARY EMBODIMENTS

### First Embodiment

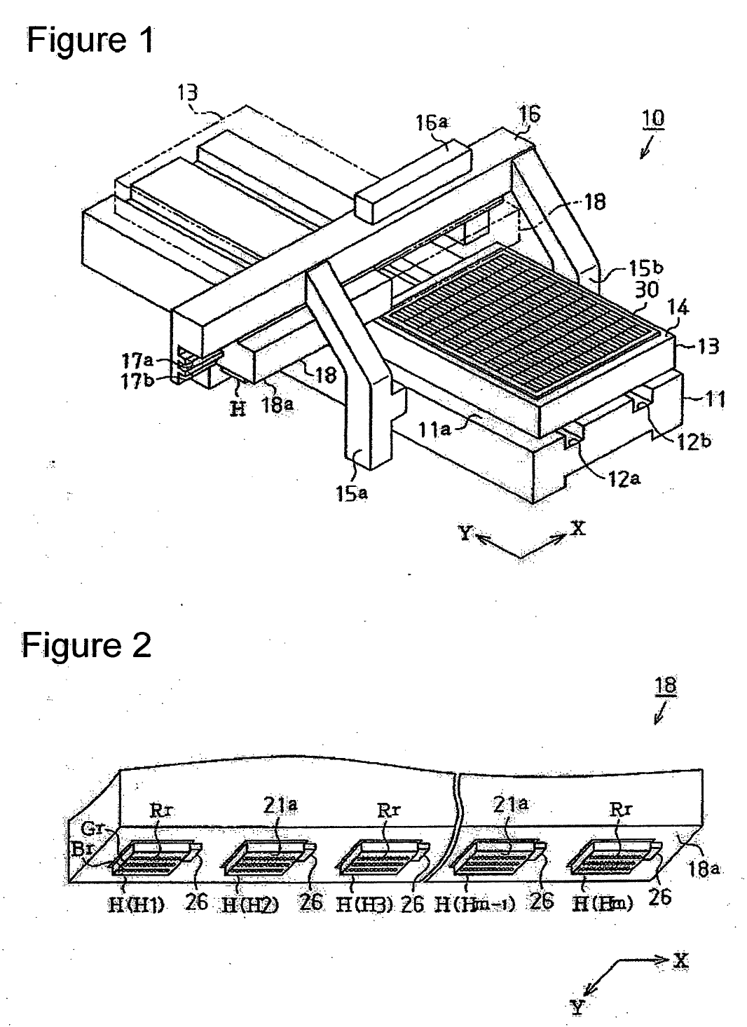

A first embodiment of the invention is described below with reference to FIGS. 1 through 11. FIG. 1 is a perspective view showing the structure of a droplet discharge device as a pattern forming device.

As shown in FIG. 1, a droplet discharge device 10 is provided with a base 111 formed in a rectangular shape. In the present embodiment, the length direction of the base 11 is designated the Y direction, and the direction perpendicular to the Y direction is designated the X direction.

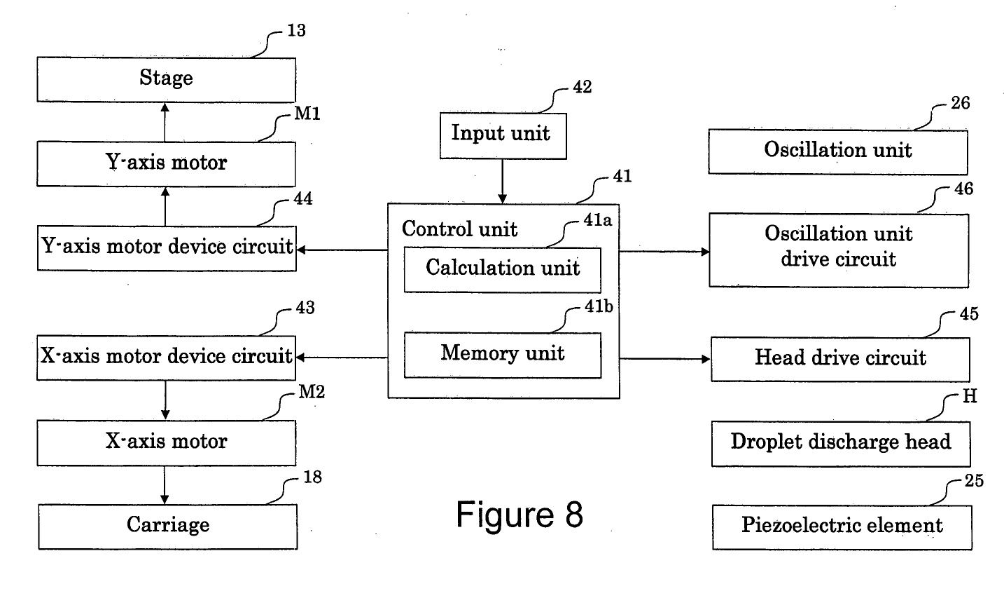

One pair of guide channels 12a and 12b extending in the Y direction are formed across the entire width in the Y direction on the top surface 11a of the base 11. A stage 13, which configures a scanning means provided with a direct-drive mechanism not shown in the drawing and corresponding to the pair of guide channels 12a and 12b, is mounted on the top side of the base 11. The direct-drive mechanism of the stage 13 is, for example, a screw type direct-drive mechanism provided with a screw shaft (drive shaft) extending in the Y direction along the guide channels 12a and 12b, and a ball nut which screws on the screw shaft, and the drive shaft is connected to the Y-axis motor M1 (refer to FIG. 8) capable of normal and reverse rotation in step units upon receiving a predetermined pulse signal. When a drive signal related to a predetermined number of steps is input to the Y-axis motor M1, the Y-axis motor M1 rotates in a normal direction or a reverse direction, such that the stage 13 travels outward or travels backward (scan in the Y direction) at a predetermined speed (scan speed V) along the Y direction by an amount relative to the number of steps. In the present embodiment, the position (solid line in FIG. 1) at which the stage 13 is disposed in the forefront most side of the guide channels 12a and 12b (base 11) is designated the outbound position, and the position (dashed line in FIG. 1) at which the stage 13 is disposed at the innermost side of the guide channels 12a and 12b (base 11) is designated the return position.

An installation surface 14 is formed on the top surface of the stage 13, and a suction type plate chock mechanism not shown in the drawing is provided on the installation surface 14. When a transparent substrate 31 (color filter substrate 30) is installed as a substrate described later on the installation surface 14, the color filter substrate 30 is positioned and fixed there at a predetermined position on the installation surface 14 by the substrate chock mechanism.

A pair of supports 15a and 15b rise at the bilateral sides of the base 11 in the X direction, and a guide member 16 extending in the X direction is provided on the pair of supports 15a and 15b. The guide member 16 is formed such that the width in the length direction is longer than the width of the stage 13 on the X direction, and arranged such that one end overhangs from the support 15a side.

A tank 16a for accommodating a suppliable function liquid L (refer to FIG. 4) described later is provided on the top side of the guide member 16. Provided on the bottom side of the guide member 16 are a pair of top and bottom convex guide rails 17a and 17b extending in the X direction across the entire width on the X direction. A carriage 18, which is provided with a direct-drive mechanism not shown in the drawing and corresponding to the guide rails 17a and 17b, is mounted on the pair of guide rails 17a and 17b.

The carriage 18 has a rectangular shape, in which the width in the length direction (X direction) is somewhat longer than the width of the stage 13 in the X direction. The direct-drive mechanism of the carriage 18 is, for example, a screw type direct-drive mechanism provided with a screw shaft (drive shaft) extending in the X direction along the guide rails 17a and 17b, and a ball nut which screws on the screw shaft, and the drive shaft is connected to the X-axis motor M2 (refer to FIG. 8) capable of normal and reverse rotation in step units upon receiving a predetermined pulse signal. When a drive signal related to a predetermined number of steps is input to the X-axis motor M2, the X-axis motor M2 rotates in a normal direction or a reverse direction, such that the carriage 18 travels outward or travels backward (scan in the X direction) along the X direction by an amount relative to the number of steps. In the present embodiment, the position (solid line in FIG. 1) at which the carriage 18 is disposed closest to the support 15a side of the guide rails 17a and 17b is designated the outbound position, and the position (dashed line in FIG. 1) at which the carriage 18 is disposed closest to the support 15b side of the guide rails 17a and 17b is designated the return position.

As shown in FIG. 2, a plurality of droplet discharge heads H are arranged in the X direction on the bottom side of the carriage 18 (the surface on the stage 13 side is the head arrangement surface 18a). The droplet discharge heads H are arrayed sequentially from the left side of the head array surface 18a (outbound position side of the carriage 18) in the X direction in the order of first droplet discharge head H1, second droplet discharge head H2, . . . , m^{th} droplet discharge head Hm.

As shown in FIG. 4, respective nozzle plates 21 are provided on the bottom side of each droplet discharge head H. On the bottom surface of the nozzle plate 21 (the surface on the stage 13 side is the nozzle surface 21a) are formed 180 individual through holes (red nozzles R configuring the droplet discharge nozzle) which open upward. The red nozzles R are arrayed sequentially from the left side of the nozzle surface 21a in the X direction (the outbound position side of the carriage 18) in the order of a first red nozzle R1, second red nozzle R2, . . . , 180^{th} red nozzle R180 at a predetermined pitch width (nozzle pitch width Wn). In the present embodiment, the nozzle pitch width Wn is 35.278 μm.

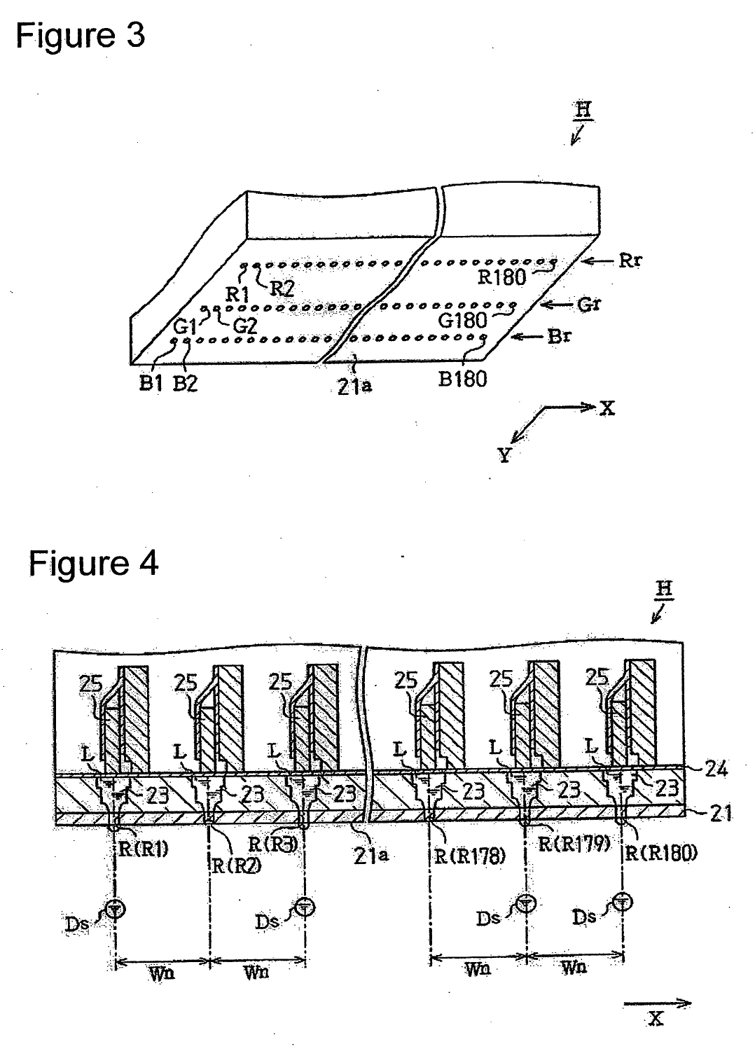

As shown in FIG. 3, the red nozzle array Rr is formed along the X direction on the nozzle surface 21a by arranging the red nozzles R in the X direction. On the nozzle surface 21a on the innermost side in the Y direction of the red nozzle array Rr (outbound position side of the stage 13) are also formed, similar to the red nozzles R, green nozzles G configured by 180 individual green nozzles (first green nozzle G1, second green nozzle G2, . . . , 180^{th} green nozzle G180), and a green nozzle array Gr is formed by the green nozzles G. On the nozzle surface 21a on the innermost side in the Y direction of the red nozzle array Rr (return position side of the stage 13) are also formed, similar to the red nozzles R and green nozzles G, blue nozzles B configured by 180 individual blue nozzles (first blue nozzle B1, second blue nozzle B2, . . . , 180^{th} blue nozzle B180), and a blue nozzle array Br is formed by the blue nozzles B.

That is, a red nozzle array Rr configured by 180 individual red nozzles R, green nozzle array Gr configured by 180 individual green nozzles G, and blue nozzle array Br configured by 180 individual blue nozzles B are formed sequentially in the Y direction from the front side of the nozzle surface 21a of each droplet discharge head H.

As shown in FIG. 4, cavities 23 are formed on the top side of the nozzle plate 21 at positioned corresponding to the red nozzles R (green nozzles G, blue nozzles B) so as to be connected to the tank 16a to be capable of supplying the function liquid L within the tank 16a into the nozzles R, G, B of each color corresponding thereto. On the top side of the cavity 23 are formed an oscillation plate 24, which increases and decreases the volume of the cavity 23 by oscillating in vertical directions, and a piezoelectric element 25, which oscillates the oscillation plate 24 to expand and contract in vertical directions.

When the droplet discharge head H receives a nozzle drive control signal that controls the actuation of the piezoelectric element 25, the piezoelectric element 25 expands and reduces the volume of the cavity 23, such that the decreased volume amount of the function liquid L is discharged from the corresponding color nozzle R, G, B as micro droplets Ds.

Each cavity 23 is supplied with a function liquid L containing a colored layer forming material as a pattern forming material for respectively forming corresponding red color layers (red colored layers Lr1˜Lrn) (refer to FIG. 11), green colored layers (Lg1˜Lgn) (refer to FIG. 11), and blue colored layers (Lb1˜Lbn) (refer to FIG. 11). The micro droplets Ds of the function liquid L containing the colored layer material of the respective color is discharged from the nozzles R, G, B. That is, a function liquid L containing the red colored layer forming material is discharged from the red nozzles R, a function liquid L containing the green colored layer forming material is discharged from the green nozzles G, and a function liquid L containing the blue colored layer forming material is discharged from the blue nozzles B.

As shown in FIG. 2, an oscillation unit 26 is provided as an oscillation means on the right side of each droplet discharge head H in the X direction (the outbound position side of the carriage 18). The oscillation unit 26 is provided with an oscillating element (for example, a magnetostrictive oscillator) that oscillates with a predetermined amplitude (head amplitude value A) and predetermined frequency (Head frequency fh), so as to move reciprocatingly (oscillate) along the X direction at a head amplitude value A and head frequency fh.

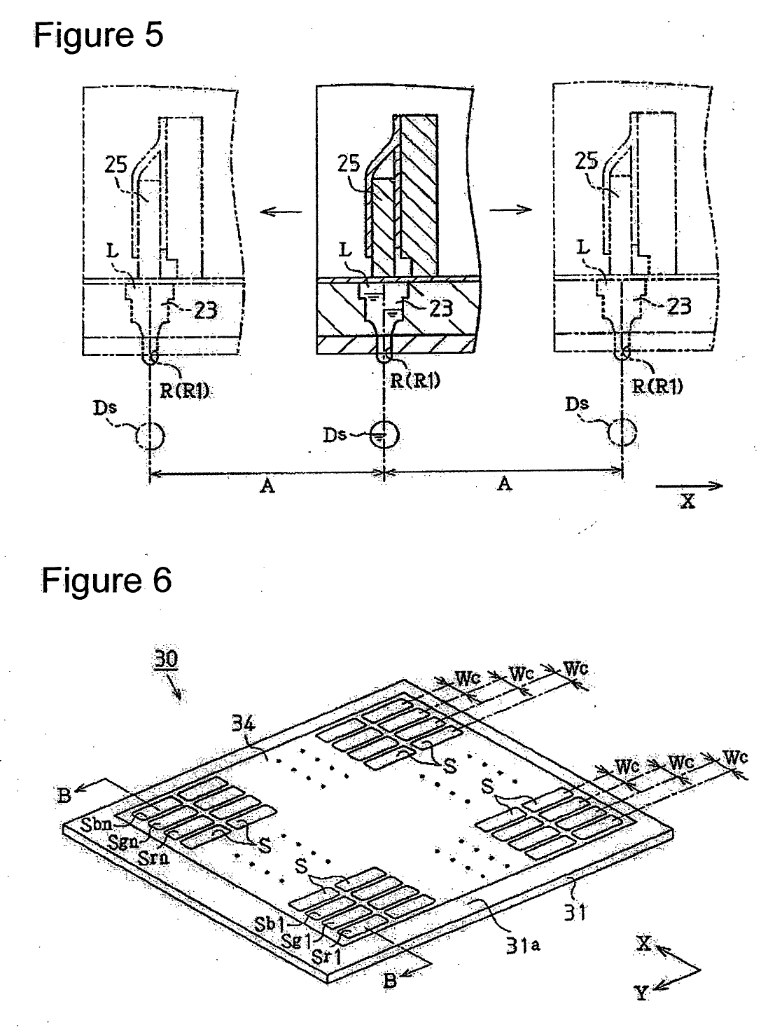

When the oscillation unit 26 receives an oscillation unit drive control signal for oscillating the droplet discharge head H, the oscillation unit 26 imparts to the corresponding droplet discharge head H an oscillation of head amplitude value A and head frequency fh in the X direction. Thus, as shown in FIG. 5, the micro droplets Ds discharged from the color nozzles R, G, and B are discharged from positions displaced in the X direction by the displacement amount of the droplet discharge head H (nozzles R, G, B) at the time of discharge. That is, the position of the impinging micro particle Ds is displaced in the X direction within the range of the head amplitude value A based on the condition of the non-oscillating color nozzles R, G, B (stationary state is indicated by the solid line position in FIG. 5).

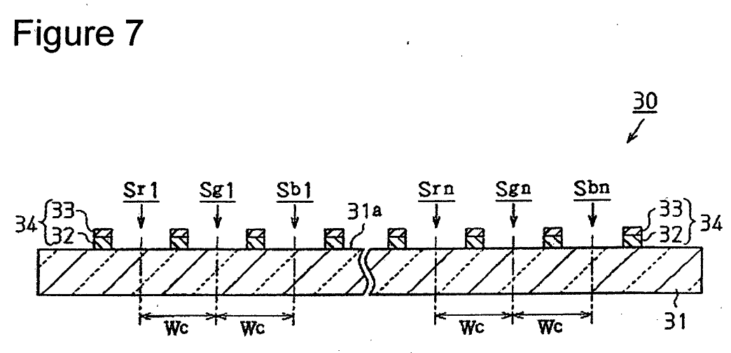

As shown in FIG. 1, a color filter substrate 30 is installed as an opposite substrate on the installation surface 14 of the stage 13. FIG. 6 is a perspective view of the color filter substrate 30, and FIG. 7 is a cross section view on the B-B line of FIG. 6.

As shown in FIG. 6, the color filter substrate 30 is provided with a square-shaped transparent substrate 31 formed of non-alkali glass. As shown in FIG. 7, a light shield layer 32 is laminated on the droplet discharge head H side (filter forming surface 31a) of one side of the transparent substrate 31. The light shield layer 32 is formed by a resin containing light shielding material, such as chrome, carbon black or the like, and is formed in a lattice with intersections in the XX direction and Y direction. A liquid repelling layer 33 is formed on the top layer of the light shield layer 32. The liquid repelling layer 33 is formed by a fluorine resin that repels the micro droplets Ds of the function liquids L.

A partition layer 34, which has a lattice shape with intersections in the X direction and Y direction, is formed by the light shield layer 32 and liquid repelling layer 33. As shown in FIG. 6, colored layer forming region S is formed in sections as pattern forming regions configured by red colored layer forming regions Sr1˜Srn for forming red colored layers Lr1˜Lrn (refer to FIG. 11), green colored layer forming regions Sg1˜Sgn for forming green colored layers Lg1˜Lgn (refer to FIG. 11), and blue colored layer forming regions Sb1˜Sbn for forming blue colored layers Lb1˜Lbn (refer to FIG. 1), over the entire surface of the filter forming surface 31a by the lattice-like partition layer 34.

As shown in FIG. 6, the colored layer forming region S is configured such that the pitch width in the X direction is the colored layer pitch width Wc. The colored layer forming regions S are arrayed sequentially from the left side of the filter forming surface 31a in the X direction in the order of a first red colored layer forming region Sr1, first green colored layer forming region Sg1, first blue colored layer forming region Sb1, . . . , nth red colored layer forming region Srn, n^{th} green colored layer forming region Sgn, and n^{th} blue colored layer forming region Sbn. In the present embodiment, the colored layer pitch width Wc is larger than the nozzle pitch width Wn (35.278 μm), that is, 42.000 μm.

The electrical structure of the droplet discharge device 10 is described below. FIG. 8 is a block diagram showing the electrical structure of the droplet discharge device 10.

As shown in FIG. 8, the droplet discharge device 10 is provided with a control unit 41 as a control means. The control unit 41 is provided with a calculation unit 41a, such as a CPU or the like, and a memory unit 41b, such as a ROM, RAM or the like, and executes processing operations (droplet discharge operations) for discharging micro droplets from the color nozzles R, G, and B.

The calculation unit 41a references pitch map data set beforehand for discharging the micro droplets Ds, and outputs corresponding types of drive control signals (for example, nozzle drive control signals, oscillation unit drive control signals and the like) to each type of drive circuit.

The memory unit 41b stores various types of data and various types of programs required for the droplet discharge operation. For example, the memory unit 41b stores a droplet discharge program for discharging micro droplets Ds. The memory unit 41b also stores pitch map data, head amplitude values A, head frequencies fh, and stage 13 scanning speeds V. Furthermore, the memory unit 41b stores the drive voltages of the piezoelectric element 25 for setting the weight of the micro droplets Ds at a predetermined weight.

Although the head amplitude value A is set at 30 μm, the head frequency fh is set at 200 Hz, the stage 13 scanning speed V is set at 200 mm/second, and the weight of the micro droplets Ds is set at increments of 0.1 ng within a range of 1.9˜2.7 ng in the present embodiment, the setting vales are not limited to these values.

The control unit 41 is electrically connected to an input unit 42, and executes various types of processes based on the various types of control signals received from the input unit 42.

The control unit 41 is electrically connected to the X-axis motor drive circuit 43, and outputs X-axis motor drive control signals to the X-axis motor drive circuit 43. The X-axis motor drive circuit 43 controls the normal rotation and reverse rotation of the X-axis motor M2 so as to control the reciprocating movement of the carriage 18 in response to the X-axis motor drive control signals from the control unit 41.

The control unit 41 is electrically connected to the Y-axis motor drive circuit 44, and references the scanning speed V (200 mm/second) to output Y-axis motor drive control signals to the Y-axis motor drive control circuit 44. The Y-axis motor drive control circuit 44 controls the normal rotation and reverse rotation of the Y-axis motor M1 so as to control the reciprocating movement of the stage 13 at a scanning speed V in response to the Y-axis motor drive control signals from the control unit 41.

The control unit 41 is electrically connected to the head drive circuit 45, and references the drive voltage of the piezoelectric element 25 corresponding to a predetermined weight, generates a nozzle drive control signal at a predetermined frequency (the discharge frequency fin is 10 kHz in the present embodiment), and outputs the nozzle drive control signal to the head drive circuit 45. The head drive circuit 45 controls the actuation of the piezoelectric element 25 of the corresponding color nozzles R, G, and B in response to the nozzle drive control signals from the control unit 41, and discharges micro droplets Ds of a weight corresponding to the nozzle drive control signals from the corresponding color nozzles R, G, B toward the filter forming surface 31a by a discharge frequency fn.

The control unit 41 is electrically connected to the oscillation unit drive circuit 46, and references the head amplitude value A (30 μm) and head frequency fh (200 Hz), generates an oscillation unit drive control signal, and outputs the oscillation unit drive control signal to the oscillation unit drive circuit 46. The oscillation unit drive circuit 46 oscillates the corresponding oscillation unit 26 at the head amplitude value A and head frequency fh in response to the oscillation unit drive control signal from the control unit 41.

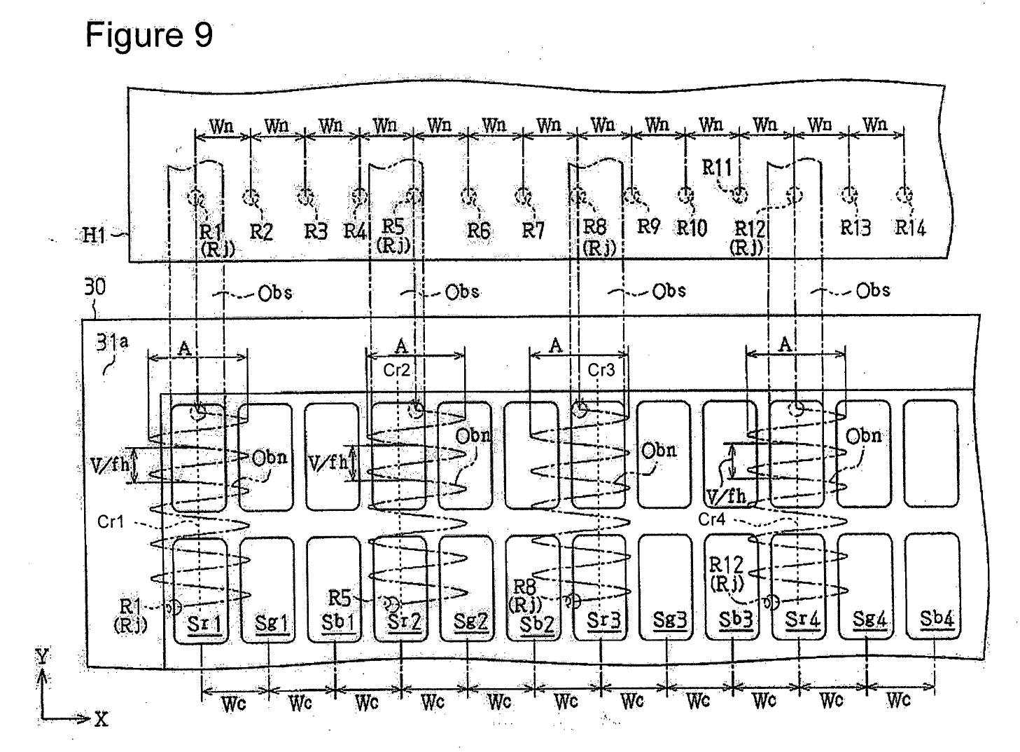

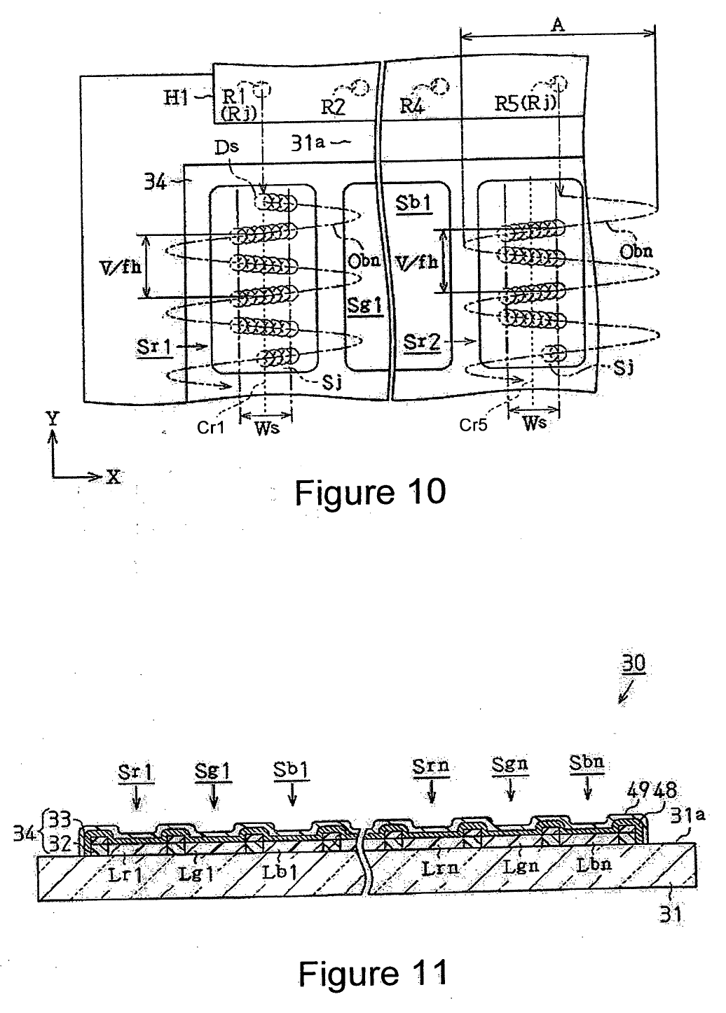

The droplet discharge operation for discharging micro droplets Ds in the color layer forming regions S by the droplet discharge device 10 is described below. Since the droplet discharge operations for the green colored layer forming regions Sg1˜Sgn and blue colored layer regions Sb1˜Sbn are performed by the same method as the droplet discharge operation for the red colored layer regions Sr1˜Srn, the droplet discharge operation for the red colored layer regions Sr1˜Srn is the focus below to facilitate the description. FIGS. 9 and 10 describe the droplet discharge operation of the droplet discharge device 10.

The droplet discharge device 10 is in a state wherein the stage 13 and carriage 18 installed on the color filter substrate 30 are positioned at their respective outbound positions.

When an operation signal for the droplet discharge operation is received from the input unit 42, the control unit 41 reads the droplet discharge program and bit map data from the memory unit 41b, and executes the droplet discharge program.

That is, the control unit 41 first outputs an X-axis drive control signal through the X-axis motor drive circuit 43 to return the carriage 18 from the outbound position. Then, the control unit 41 arranges the center position of the first red nozzle R1 of the first droplet discharge head H on a center line Cr1 (dashed line in FIG. 9) of a movement track Obs as shown in FIG. 9. The movement track Obs is the extension of the first red colored layer forming region Sr1 in the Y direction, and is indicated by the dashed lines in FIG. 9.

Since the colored layer pitch width Wc (42,000 μm) is not formed in integer multiples of the nozzle pitch width Wn (35.273 μm), the corresponding red nozzle R is deflected from the center line Cr of the movement tracks Obs on the movement tracks Obs of the second through n^{th} red colored layer forming regions Sr2˜Srn. As shown in FIG. 9, for example, the corresponding 5^{th} red nozzle R5 is displaced to the right side in the X direction of the second red colored layer forming region Sr2 on the movement track Obs of the second red colored layer forming region Sr2. Furthermore, on the movement track Obs of the third red colored layer forming region Sr3, the corresponding 8^{th} red nozzle R8 is displaced to the left side in the X direction of the third red layer forming region Sr3.

In the present embodiment, in the stationary state, the red nozzles R (for example, the first red nozzle R1, fifth red nozzle R5, and eighth red nozzle R8, and twelfth red nozzle R12 in FIG. 9) positioned on the movement tracks Obs of the red colored layer forming regions Sr1˜Srn are designated discharge reference nozzles Rj.

When the center position of the first red nozzle R1 is positioned on the center line Cr1 of the movement track Obs of the first red colored layer forming region Sr1, the control unit 41 outputs a Y-axis motor drive control signal to the Y-axis motor drive circuit 44 to move the stage 13 from the outbound position at a scanning speed V (200 mm/second). That is, the control unit 44 relatively moves the stationary discharge reference nozzles Rj toward the corresponding red colored layer forming regions Sr1˜Srn at a scanning speed V (200 mm/second).

Then, When the relatively moving discharge reference nozzles Rj enter the corresponding red colored layer forming region Sr1˜Srn, the control unit 41 outputs oscillation unit drive control signals top the oscillation unit drive circuit 46 to oscillate each oscillation unit 26. That is, the control unit 44 imparts an oscillation of an amplitude of the head amplitude value A (30 μm) in the X direction and a frequency of the head frequency fh (200 Hz) to each droplet discharge head H.

Thus, as shown in FIG. 9, the center positions of the stationary discharge reference nozzles Rj is relatively moved along a sine wave path (nozzle movement track Obn) in the red colored layer forming regions Sr1˜Srn by means of the oscillation in the X direction imparted by the oscillation unit 26 and the relative movement of the stage 13 in the Y direction.

The nozzle movement track Obn of the discharge reference nozzles Rj are sine wave paths having an amplitude of the head amplitude value A (30 μm), and wavelength of the scan speed V divided by the head frequency fh. The nozzle movement track Obn of the present embodiment is a track in which the center position of the discharge reference nozzles Rj repeatedly weave in and out of the corresponding red colored layer forming regions Sr1˜Srn, because the discharge reference nozzles Rj oscillate at a head amplitude value A (30 μm) that is one half or more of the colored layer colored layer pitch width Wc (42.000 μm). As shown in FIG. 9, for example, the first red nozzle R1 repeatedly waves in and out from the first red colored layer forming region Sr1 to the adjacent first green colored layer forming region Sg1. The fifth red nozzle R5 weaves in and out from the second red colored layer forming region Sr2 to the adjacent second green colored layer forming region Sg2. The eighth red nozzle R8 weaves in and out from the third red colored layer forming region Sr3 to the adjacent second blue colored layer forming region Sb2.

During the relative movement of each discharge reference nozzle Rj along the nozzle movement track Obn, the control unit 41 outputs a nozzle drive control signal with the following timing through the head drive circuit 45 to the piezoelectric element 25 of the same discharge reference nozzle Rj.

That is, as shown in FIG. 10, the control unit 41 outputs a nozzle drive control signal having a discharge frequency fn (10 kHz) when the center position of the discharge reference nozzle Rj is positioned at a distance shorter than a predetermined distance from the center line Crj of the corresponding red colored layer forming region Sr1˜Srn. Specifically, when the discharge reference nozzle Rj confronts a region (discharge region Sj) configured with a predetermined width (discharge tolerance width Ws) at the center of which is the center line Cr of the red colored layer forming regions Sr1˜Srn, the control unit 41 outputs a nozzle drive control signal to the piezoelectric element 25 of the same discharge reference nozzle Rj. In the present embodiment, the discharge tolerance width Ws is set at 20 μm.

For example, in the case of the first red nozzle R1, the center position of the first red nozzle R1 simultaneously enters the discharge region Sj when entering the first red colored layer forming region Sr1, as shown in FIG. 10. Therefore, the control unit 41 starts the discharge of the micro droplets Ds with the timing at which the center position of the first red nozzle R1 enters the first red colored layer forming region Sr1. Thereafter, the control unit 41 discharges micro droplets Ds at a discharge frequency fn (10 kHz) only when the first red nozzle R1 confronts the discharge region Sj.

In the case of the fifth red nozzle R5, however, the center position is positioned outside the discharge region Sj at the right side end in the X direction of the second red colored layer forming region Sr2 when the fifth red nozzle R5 enters the second red colored layer forming region Sr2. Therefore, the control unit 41 starts the discharge of the micro droplets Ds with the timing when the center position of the fifth red nozzle R5 is temporarily outside the second red colored layer forming region Sr2 and again enters the second red colored layer forming region Sr2 (discharge region Sj). Then, similar to the first red nozzle R1, the control unit 41 discharges the micro droplets Ds at a frequency fn (10 kHz) only when the fifth red nozzle R5 confronts the discharge region Sj.

In this way micro droplets Ds are uniformly discharged only during the discharge reference nozzle Rj is oscillated within the red colored layer forming regions Sr1˜Srn. Then, the micro droplets Ds discharged within the discharge region Sj are reliably received within the corresponding red colored layer forming regions Sr1˜Srn without leakage to the adjacent green colored layer forming regions Sg1˜Sgn or blue colored layer forming regions Sb1˜Sbn.

During this time, the control unit 41 outputs nozzle drive control signals for discharging the micro droplets Ds at the following weight setting through the head drive circuit 45 to the piezoelectric element 25 of each discharge reference nozzle Rj. That is, the control unit 41 outputs nozzle drive control signals at a weight setting that equalizes the total amount (total weight) of the micro droplets Ds discharged to each red colored layer forming region Sr1˜Srn.

Specifically, thirty-six micro droplets Ds are dischargeable in the first red colored layer forming region Sr1, as shown in FIG. 10, and the control unit 41 outputs nozzle drive control signals for discharging micro droplets Ds that weigh 2.1 ng each to the first red colored layer forming region Sr1. In this way a total weight of 75.6 ng of the function liquid L is discharged to the first red colored layer forming region Sr1.

As shown in FIG. 10, thirty micro droplets Ds are dischargeable in the second red colored layer forming region Sr2, and the control unit 41 outputs a nozzle drive control signal for discharging micro droplets Ds that weigh 2.5 ng each in the second red colored layer forming region Sr2. Accordingly, the same total weight of 75.0 ng of the function liquid L is discharged within the second red colored layer forming region Sr2 as is discharged within the first red colored layer forming region Sr1. Then, the control unit 41 similarly outputs nozzle drive control signals at weight settings that equalize the total weight for the other red colored layer forming regions Sr3˜Srn.

Thus, the function liquids L of equalized total weights are accommodated within the red colored layer forming regions Sr1˜Srn.

Thereafter, the control unit 41 similarly outputs respective nozzle drive control signals to corresponding discharge reference nozzles Rj, and the function liquids L of equalized total weights are accommodated within the red colored layer forming regions Sr1˜Srn. At this time the control unit 41 equalizes the total weight of the respective function liquids L which are uniformly accommodated in the corresponding green colored layer forming regions Sg1˜Sgn and blue colored layer forming regions Sb1˜Sbn, similar to the red colored layer forming regions Sr1˜Srn.

Then, the function liquids L accommodated within the red colored layer forming regions Sr1˜Srn are dried so as to solidify the red colored layer forming material contained in the function liquid L, thereby forming respective red colored layers Lr1˜Lm within the corresponding red colored layer forming regions Sr1˜Srn, as shown in FIG. 11.

Accordingly, red colored layers Lr1˜Lrn having uniform shapes can be formed simply by uniformly accommodating the function liquids L having equalized total weights within the red colored layer forming regions Sr1˜Srn. Similarly, green colored layers Lg1˜Lgn and blue colored layers Lb1˜Lbn (refer to FIG. 11) having uniform shapes can be formed within the green colored layer forming regions Sg1˜Sgn and blue colored layer forming regions Sb1˜Sbn.

When the colored layers Lr1˜Lm, Lg1˜Lgn, and Lb1˜Lbn having uniform shapes are formed in the colored layer forming regions S, a common electrode layer 48 configured as a transparent conductive film, such as ITO or the like, then an orientation layer 49 subjected to orientation process, such as a rubbing process or the like, are sequentially laminated on the top layer of the colored layer. Thus, a color filter substrate 30 provided with colored layers having uniform shapes can be manufactured.

The effects of the first embodiment having the previously described construction are described below.

The first embodiment provides an oscillation unit 26 for imparting an oscillation at a head amplitude value A and head frequency fh to each droplet discharge head H, such that the droplet discharge head H is oscillated by the oscillation unit 26 when the discharge reference nozzle Rj enters the corresponding red colored layer forming region Sr1˜Srn. Then, when the center position of the discharge reference nozzle Rj confronts the discharge region Sj of the corresponding red colored layer forming region Sr1˜Srn, the micro droplets Ds are discharged from the discharge reference nozzle Rj to form the red colored layers Lr1˜Lm. The respective green colored layers Lg1˜Lgn and blue colored layers Lb1˜Lbn are formed since the green colored layer forming regions Sg1˜Sgn and blue colored layer regions Sb1˜Sbn are configured similarly to the red colored layer regions Sr1˜Srn.

Accordingly, the range of relative movement of the red nozzles R, green nozzles G, and blue nozzles B can be enlarged for each colored layer forming region by simply oscillating the droplet discharge head H, and micro droplets Ds can be uniformly discharged in the colored layer forming regions S simply by enlarging the movement range. As a result, colored layers Lr1˜Lm, Lg1˜Lgn, and Lb1˜Lbn can be formed with uniform shapes within the colored layer forming regions S. Moreover, the production characteristics of the color filter substrate 30 can be improved.

(2) Since the micro droplets Ds are discharged when the center position of the discharge reference nozzle Rj confronts the discharge region S, the discharged micro droplets Ds broadly and uniformly wet the colored layer forming region S from near the center line. Moreover, the discharged micro droplets Ds can be reliably accommodated within the corresponding colored layer forming region S without leakage to adjacent colored layer forming regions S. Accordingly, the function liquid L can be uniformly accommodated within the colored layer forming regions S, and the colored layers can be formed with greater uniformity of shape. Moreover, the production characteristics of the color filter substrate 30 can be improved.

(3) The first embodiment adjusts the weight of the micro droplets Ds discharged from the discharge reference nozzle Rj so as to equalize the total amount (total weight) of the micro droplets Ds discharged to each red colored layer forming region Sr1˜Srn. Accordingly, the function liquids L having equalized total weights can be accommodated within the red layer forming regions Sr1˜Srn, and the shapes of the colored layers Lr1˜Lrn, Lg1˜Lgn, and Lb1˜Lbn can be uniformly formed.

### Second Embodiment

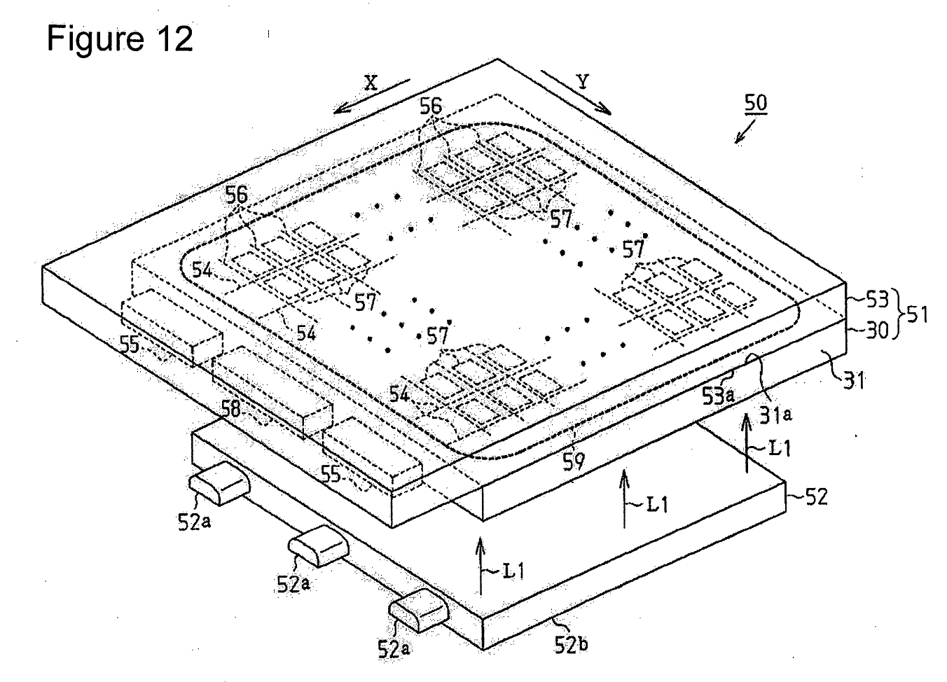

A liquid crystal display device 50 is described below as an electro-optical device provided with the above mentioned color filter substrate 30, with reference to FIG. 12. FIG. 12 is a perspective view showing the structure of the liquid crystal display device 50. In FIG. 12, the liquid crystal display device 50 is provided with a liquid crystal panel 51, and an illumination device 52 for illuminating the liquid crystal panel 51 with planar light L1.

The illumination device 52 is provided with a light source 52a such as an LED or the like, and a light guide 52b for transmitting the light emitted from the light source 52a as planar light to illuminate the liquid crystal panel 51. The liquid crystal panel 51 has a color filter substrate 30 manufactured according to the first embodiment, and a square shaped element substrate 53 on the illumination device 52 side.

The element substrate 53 is a non-alkali glass substrate configured slightly larger than the transparent substrate 31, and a plurality of scan lines 54 extending in the X direction are formed at predetermined spacing on the surface (element forming surface 53a) on the side of the color filter substrate 30. Each scan line 54 is electrically connected to a scan line drive circuit 58 arranged at one end of the element substrate 53. The scan line drive circuit 58 selectively drives predetermined scan lines 54 from among a plurality of scan lines 54 with a predetermined timing and outputs scan signals to the selected scan lines 54 based on scan control signals supplied from a control circuit not shown in the drawing. A plurality of data lines 56 extending in the Y direction and perpendicular to the scan lines 54 are formed at predetermined spacing on the element forming surface 53a. Each data line 56 is electrically connected to a data line drive circuit at one end of the element substrate 53. The data line drive circuit 55 generates data signals based on display data supplied from an external device not shown in the drawing, and outputs the generated data signals to the corresponding data lines 56 with a predetermined timing.

A plurality of pixel regions 57 arrayed in a matrix pattern are formed by connecting the corresponding data lines 56 and scan lines 54 at positions where the data lines 56 and scan lines 54 intersect. A pixel electrode, which is configured by a switch element formed of TFT or the like not shown in the drawing and a transparent conductive film such as ITO or the like, is formed within the pixel region 57. That is, the liquid crystal display device 50 is a liquid crystal display device of the active matrix type provided with TFT switching elements.

The element substrate 53 ands color filter substrate 30 are adhered by a square frame-like sheet member 59 with the pixel electrodes of the element substrate 53 relatively facing the colored layers (red colored layers Lr1˜Lrn, green colored layers Lg1˜Lgn, and blue colored layers Lb1˜Lbn) of the color filter substrate 30. Then, a liquid crystal layer is injected as an electro-optical material layer not shown in the drawing in the gap between the element substrate 53 and the color filter substrate 30.

When the scan line drive circuit 58 sequentially selects one scan line 54 based on line sequence scanning, the control elements of the pixel regions 57 are sequentially turned ON only during the selection period. When the control element is turned ON, data signals output from the data line drive circuit 55 are output to the pixel electrodes through the data line 56 and control element. Thus, the orientation state of the liquid crystal molecules are maintained so as to modulate the illumination light L1 of the illumination device 52 in accordance with the difference in potential between the pixel electrode of the element substrate 53 and the common electrode layer 48 of the color filter substrate 30. Then, a desired full color image is displayed on the liquid crystal panel 51 through the color filter substrate 30 depending on whether or not the modulated light is transmitted through a polarization panel not shown in the drawing.

In this case, color irregularities can be avoided in the colored layers Lr1˜Lrn, Lg1˜Lgn, Lb1˜Lbn, and production characteristics of the liquid crystal device 50 can be improved simply by forming uniform colored layers on the color filter substrate 30.

The above embodiments may be variously modified as described below.

Although the droplet discharge head H is configured so as to oscillate only in the X direction in the first embodiment, the invention is not limited to this direction inasmuch as, for example, the oscillation may be in a direction inclined relative to the X direction. That is, the oscillation direction of the droplet discharge head H may be a direction other than the Y direction that enlarges the relative movement range of the nozzles R, G, B relative to the colored layer forming region S.

Although an oscillation unit 26 is provided to impart an oscillation to the droplet discharge head H in the first embodiment, the invention is not limited to this provision inasmuch as the oscillation to the droplet discharge head H may be imparted by, for example, the normal and reverse rotation of the X-axis motor M2. In this case, the color filter substrate 30 having colored layers of uniform shape can be manufactured without providing the oscillation unit 26 and oscillation unit drive circuit 46.

Although the droplet discharge head H is oscillated relative to the transparent substrate 31 in the first embodiment, the invention is not limited to this configuration inasmuch as the stage 13 may be oscillated relative to the droplet discharge head H in a direction different from the Y direction.

In the first embodiment, the total amount (total weight) of the function liquid L is uniformly applied within the colored layer forming region S by setting the weight of the micro droplets Ds. However, the invention is not limited to this method inasmuch as the total amount (total number, total volume) of the function liquid L may be uniformly applied within the colored layer forming region S by, for example, setting the number of droplets to be discharged within the colored layer forming region S.

Although the micro droplets Ds are discharged only when the discharge reference nozzle Rj enters the region (discharge region Sj) configured by a predetermined width (discharge tolerance width Ws) in the first embodiment, the invention is not limited to this method inasmuch as the micro droplets Ds may be discharged, for example, only when the discharge reference nozzle Rj enters the corresponding colored layer forming region S.

In the first embodiment, the pattern, pattern forming surface, and pattern forming region are realized in the respective colored layers, filter forming surface 31a, and colored layer forming region S to manufacture the color filter substrate 30. However, the invention is not limited to this method inasmuch as the pattern, pattern forming surface, and pattern forming region may be realized in an organic electroluminescent element (organic EL element) as a light-emitting element formed on a transparent substrate, one side surface of the transparent substrate (light-emitting element forming surface), and light-emitting element forming region, and forming light-emitting element by discharging droplets of function liquid containing light-emitting element forming material in the light-emitting element forming region. In this way it is possible to manufacture an organic electroluminescent display (organic EL display) as an electro-optical device having light-emitting elements of improved shape uniformity. Alternatively, the pattern and pattern forming surface also may be realized by metal wiring and circuit forming surface to manufacture a printed circuit board.

Although the colored layer regions are arrayed in stripes in the first embodiment, the invention is not limited to this arrangement inasmuch as the shape may be, for example, mosaic-like or delta-like, although the shape is not limited to these examples.

Although the droplet discharge head H is provided with a red nozzle array Rr, green nozzle array Gr, and blue nozzle array Br in the first embodiment, the invention is not limited to this arrangement inasmuch as each droplet discharge head H may be provided with any one among the red nozzle array Rr, green nozzle array Gr, and blue nozzle array Br.

Although the nozzles arrays Rr, Gr, Br are arranged along the X direction in the first embodiment, the invention is not limited to this arrangement inasmuch as the nozzle arrays Rr, Gr, Br may be arranged at an inclination relative to the X direction. In this way the nozzle pitch width Wn viewed from the Y direction may be reduced, and the stationary position of the discharge reference nozzle Rj can be brought nearer to the center line of each colored layer forming region S simply by inclining the nozzle arrays Rr, Gr, Br.

Although the micro droplets Ds are discharged by actuating a piezoelectric element 25 in the first embodiment, the invention is not limited to this method inasmuch as the micro droplets Ds may be discharged by, for example, forming air bubbles within the cavity 23 by heating via resistance heating, then rupturing the air bubbles.

Although colored layers (color filter substrate 30) having uniform shape are put in the liquid crystal display device 50 in the second embodiment, the invention is not limited to this arrangement inasmuch as the colored layers having uniform shape may be put (laminated) in, for example, an organic EL display.

Although the liquid crystal display device 50 realizes the electro-optical device in the second embodiment, the invention is not limited to this realization inasmuch as, for example, the electro-optical device may be realized as an organic EL display, or field effect display (FED, SED and the like) provided with planar electron discharge elements and which uses the light emitted by a fluorescent material caused by electrons discharged from the elements.

This application claims priority to Japanese Patent Application No. 2005-013701. The entire disclosure of Japanese Patent Application No. 2005-013701 is hereby incorporated herein by reference.

What is claimed is:

1. A pattern forming method for forming a pattern on a substrate that has a pattern forming region on its one surface, the pattern forming method comprising:
scanning in a first direction the substrate provided with the pattern forming region; and
discharging droplets containing pattern forming material into the pattern forming region from a droplet discharge head that is provided with a droplet discharge nozzle,
wherein the droplet discharge head is relatively oscillated relative to the one surface of the substrate by oscillating one of the droplet discharge head and the one surface relative to the other of the droplet discharge head and the one surface of the substrate in a direction different from the first direction, such that the droplets are discharged from the droplet discharge nozzle when the droplet discharge head faces the pattern forming region.

2. The pattern forming method of claim 1, wherein
the droplet discharge head is relatively oscillated relative to the one surface of the substrate by oscillating the droplet discharge head in the direction different from the first direction.

3. The pattern forming method of claim 1, wherein
the droplet discharge head is relatively oscillated relative to the one surface of the substrate by oscillating the substrate in the direction different than from the first direction.

4. The pattern forming method of claim 1, wherein
the droplet discharge head is relatively oscillated relative to the one surface of the substrate in a direction perpendicular to the first direction within the one surface of the substrate.

5. The pattern forming method of claim 1, wherein
droplets are discharged from the droplet discharge nozzle, such that a total amount of droplets discharged from the droplet discharge nozzle to each of a plurality of pattern forming regions formed on the one surface of the substrate is uniform.

6. The pattern forming method of claim 5, wherein
the total amount of droplets discharged from the droplet discharge head to each of the plurality of pattern forming regions is made uniform by adjusting at least one of the number and the weight of the droplets discharged from the droplet discharge nozzle.

7. The pattern forming methods of claim 1, wherein
the droplets are discharged from the droplet discharge nozzle when the droplet discharge nozzle is positioned at a distance shorter than a predetermined distance from a center line of the pattern forming region, the center line being parallel with the first direction.

8. A droplet discharge head, comprising:
a droplet discharge nozzle from which droplets containing pattern forming material are configured to be discharged onto a pattern forming region of a substrate that is scanned in a first direction; and
an oscillation unit configured to oscillate the droplet discharge nozzle in a direction different from the first direction.

9. A pattern forming device comprising
a scanning unit configured to scan in a first direction a substrate having a pattern forming region on its one surface;
a droplet discharge head having a droplet discharge nozzle from which droplets containing pattern forming material are configured to be discharged in the pattern forming region;
an oscillating unit configured to relatively oscillate the droplet discharge head relative to the one surface of the substrate in a direction different from the first direction; and
a control unit configured to control the droplet discharge nozzle so as to discharge droplets when the droplet discharge nozzle faces the pattern forming region.

10. The pattern forming device of claim 9, wherein
the oscillation unit is disposed adjacent to the droplet discharge head, and is configured to impart a predetermined oscillation to the droplet discharge head.

11. A method for manufacturing a color filter substrate, comprising:
scanning in a first direction a substrate having a colored layer forming region on its one surface; and
discharging within the colored layer forming region droplets containing colored layer forming material from a droplet discharge head provided with a droplet discharge nozzle so as to form a colored layer in the colored layer forming region,
wherein the colored layer is formed by the pattern forming method of claim 1.

12. A color filter substrate manufactured by the method for manufacturing a color filter substrate of claim 11.

13. An electro-optic device comprising:
an element substrate and an opposite substrate; and
an electro-optic material layer disposed between the element substrate and the opposite substrate,
wherein the opposite substrate is the color filter substrate of claim 12.

14. A method for manufacturing an electro-optic device, comprising
scanning in a first direction a substrate having a light-emitting element forming region on its one surface; and
discharging within the light-emitting element forming region droplets containing light-emitting element forming material from a droplet discharge head provided with a droplet discharge nozzle so as to form a light-emitting element in the light-emitting element forming region,
wherein the light-emitting element is formed by the pattern forming method of claim 1.

15. An electro-optic device manufactured by the method for manufacturing an electro-optic device of claim 14.
